(19) United States
(12) Patent Application Publication
(10) Pub. No.: US 2015/0259465 A1
(43) Pub. Date: Sep. 17, 2015

(54) TWO-COMPONENT POLYURETHANE COMPOSITION

(71) Applicant: SIKA TECHNOLOGY AG, Baar (CH)

(72) Inventors: Urs Burckhardt, Zurich (CH); Steffen Kelch, Oberengstringen (CH); Rita Cannas, Dubendorf (CH)

(21) Appl. No.: 14/425,223

(22) PCT Filed: Sep. 6, 2013
(86) PCT No.: PCT/EP2013/068490

§ 371 Date: Mar. 2, 2015

(30) Foreign Application Priority Data
Sep. 11, 2012 (EP) 12183891.6

(51) Int. Cl. C08G 18/76; C08G 18/38; C09J 5/00; C09J 175/08; B32B 7/12; C08G 18/32; C08G 18/22

(52) U.S. Cl. CPC C08G 18/7671; C08G 18/7621; C08G 18/3206; C08G 18/3819; C08G 18/3844; C08G 18/227; C09J 175/08; B32B 7/12; C09J 5/00; B32B 2250/02; B32B 2255/26; C09J 2475/00

(57) ABSTRACT

The invention relates to a two-component polyurethane composition containing a polyol, a polyisocyanate, a blocked amine and a bismuth(III)- or zirconium(IV)-catalyst. The composition is easy to process, cures quickly and without bubbles, and has unexpectedly high strengths when in its cured state. It is particularly suitable as an adhesive, sealant, coating or potting compound.

### TECHNICAL FIELD

The invention relates to the field of curable polyurethane compositions and the use thereof, especially as an adhesive, sealant or coating.

### PRIOR ART

Curable polyurethane compositions are widely used, among other things for flexible bonded joints, seals and coatings. Two-component systems offer the advantage over one-component systems in this context that they develop strength quickly, and in terms of their usage properties, they cover a broader spectrum of mechanical properties, from viscoelastic to highly structured. Two-component systems consisting of a polyol component and an isocyanate component present the challenge that their curing can be considerably impeded by moisture, which frequently results in inadequate strength. The joint use of polyamines in the polyol component means that the systems are less susceptible to interference by moisture during curing, reach higher early and final strengths, and exhibit higher stability. However, because of the rapid reaction between amino and isocyanate groups, frequently they have only a brief open time, which makes them unsuitable for many applications. Systems with a sufficiently long open time are generally only obtained with polyamines having sterically hindered and/or electronically deactivated amino groups, which react slowly with isocyanates. To make easy, solvent-free incorporation possible, it is also advantageous if the polyamine is liquid at room temperature. Under these conditions, the selection is reduced to a few industrially available polyamines, which are expensive and are toxic because of their aromatic nature.

Theoretically, compounds with blocked, hydrolytically activatable amino groups, so-called blocked amines or latent hardeners, can be used in place of polyamines; they include oxazolidines or aldimines such as are known from single-component polyurethane compositions. Such blocked amines are frequently liquid at room temperature, even if they are based on solid polyamines, and react more slowly with isocyanates because of the delayed release of amino groups. However, their use in two-component polyurethanes entails the drawback that the activation of the blocked amino groups and the reaction of the OH groups with isocyanates must be mutually tailored to one another in a suitable way so that the curing can be performed without interference, especially without the formation of bubbles, and the polymer produced can derive benefits from the blocked amine in terms of its strength.

Two-component polyurethane compositions containing blocked amines are known. In DE 4006537, two-component adhesive-containing polyazomethines, especially polyketimines, which may also contain polyols, are described. However, the strengths achieved in this way are not very high. EP 2,139,936 discloses, among others, two-component elastic adhesives containing a dialdimine in the polyol component. However, these do not cure without problems, have a tendency to form bubbles, and develop relatively low strength.

### PRESENTATION OF THE INVENTION

Therefore the objective of the present invention is to provide a two-component polyurethane composition that has a long open time and cures to form an elastic material of high strength without bubbles.

Surprisingly it was found that a composition according to claim 1 solves this problem. The open time of these compounds is relatively long and can be readily adjusted by varying the constituents. Curing largely takes place without bubble formation, even unfavorable climatic conditions such as high temperature and/or high relative humidity, with development of very high strengths at surprisingly high speeds—distinctly higher strengths than those customary for two-component compositions of the prior art. Particularly surprising in this connection is the fact that the final strengths of the composition according to claim 1 are distinctly higher than in the case of the corresponding compositions which contain other usual catalysts and/or catalysts with similar action in polyurethane chemistry, such as tertiary amines, dialkyltin(IV) compounds, tin(II) compounds, zinc(II) compounds or titanium(IV) compounds, in place of bismuth(III) or zirconium(IV) compounds. It can be hypothesized that thanks to the presence of the bismuth(III) or zirconium(IV) catalysts, the amine forming the basis for the blocked amine is incorporated so well into the curing polyurethane polymer that it contributes substantially to strengthening the polymer.

Additional aspects form the subject matter of additional independent claims. Particularly preferred embodiments of the invention are presented in the dependent claims.

### Methods of Executing the Invention

The subject matter of the invention is a composition consisting of a first and a second component,
in which the first component contains at least one polyol and
the second component contains at least one polyisocyanate,
and in which the composition also has at least one blocked amine Z, which has an oxazolidino group or an aldimino group and at least one additional reactive group selected from the group consisting of oxazolidino groups, aldimino groups, hydroxyl groups, mercapto groups, primary amino groups, secondary amino groups and isocyanate groups,
and the composition additionally contains at least one catalyst K selected from the group consisting of bismuth(III) compounds and zirconium(IV) compounds.

Substance names beginning with “poly,” such as polyol, polyisocyanate or polyamine, denote substances that contain in their formula two or more of the functional groups occurring in their names per molecule.

The term “polyisocyanate” in the present document denotes compounds with two or more isocyanate groups, regardless of whether these are monomeric diisocyanates, oligomeric polyisocyanates or isocyanate group-containing polymers with a relatively high molecular weight.

The term “polyurethane polymers” comprises all polymers produced by the so-called diisocyanate polyaddition method. The term “polyurethane polymers” also includes isocyanate group-containing polyurethane polymers, such as those that can be obtained from the reaction of polyisocyanates and polyols and are polyisocyanates themselves and are often also called prepolymers.

The term “oxazolidino group” in the present document denotes tetrahydrooxazole groups (5-membered ring) as well as tetrahydrooxazine groups (6-membered ring).

The term “primary amino group” denotes an NH₂ group that is bound to an organic radical, and “secondary amino group” is the term used for an NH group that is bound to two organic radicals, which together may also be part of a ring.

A “primary hydroxyl group” is the name given to an OH group that is bound to a C atom with two hydrogens.

The term “aliphatic” denotes an amine or an isocyanate, the amino or isocyanate group of which is bound to an aliphatic, cycloaliphatic or arylaliphatic radical; correspondingly, this group is called an aliphatic amino or isocyanate group.

The term “aromatic” denotes an amine or an isocyanate, the amino or isocyanate group of which is bound to an aromatic radical; correspondingly, this group is designated as an aromatic amino or isocyanate group.

The term “open time” in this document is applied to the time during which the composition can be processed after the first and the second component have been mixed together.

The term “strength” in the present document designates the strength of the cured composition, wherein “strength” particularly means the tensile strength and the modulus of elasticity (E-modulus) in the elongation range of up to 50%.

“Room temperature” in the present document means a temperature of 23° C.

The term “storage stable” designates the characteristic of a composition that it can be stored in a suitable container for several weeks to several months at room temperature without undergoing a substantial change in its application or use properties due to storage.

Polyols particularly suitable as constituents of the first component are the following commercially available polyols or mixtures thereof:
Polyoxyalkylene polyols, also known as polyether polyols or oligo-etherols, which are polymerization products of ethylene oxide, 1,2-propylene oxide, 1,2- or 2,3-butylene oxide, oxetane, tetrahydrofuran or mixtures thereof, possibly polymerized using a starting molecule with two or more active hydrogen atoms, for example water, ammonia or compounds with several OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforementioned compounds. Both polyoxyalkylene polyols with a low degree of unsaturation (measured according to ASTM D-2849-69 and stated in milliequivalents unsaturation per gram polyol (mEq/g)), produced for example with the aid of so-called Double Metal Cyanide Complex catalysts (DMC catalysts), and polyoxyalkylene polyols with a higher degree of unsaturation, produced for example with the aid of anionic catalysts such as NaOH, KOH, CsOH or alkali alcoholates, may be used.

Especially suitable are so-called ethylene oxide-terminated (“EO-endcapped”, ethylene oxide-endcapped) polyoxypropylene polyols. The latter are special polyoxypropylene-polyoxyethylene polyols obtained, for example, by further alkylating pure polyoxypropylene polyols, especially polyoxypropylene diols and triols, after completion of the polypropoxylation reaction with ethylene oxide so that they have primary hydroxyl groups.
Styrene-acrylonitrile- or acrylonitrile-methyl methacrylate-grafted polyether polyols.
Polyester polyols, also known as oligoesterols, produced according to known methods, especially the polycondensation of hydroxycarboxylic acids or the polycondensation of aliphatic and/or aromatic polycarboxylic acids with dihydric or polyhydric alcohols.

Especially suitable polyester polyols are those produced from dihydric to trihydric, especially dihydric alcohols, for example ethylene glycol, diethylene glycol, propylene glycol, dipropylene glycol, neopentyl glycol, 1,4-butane diol, 1,5-pentane diol, 3-methyl-1,5-hexane diol, 1,6-hexane diol, 1,8-octane diol, 1,10-decane diol, 1,12-dodecane diol, 1,12-hydroxystearyl alcohol, 1,4-cyclohexane dimethanol, dimer fatty acid diol (dimer diol), hydroxypivalic acids neopentyl glycol esters, glycerol, 1,1,1-trimethylolpropane or mixtures of the aforementioned alcohols with organic di- or tricarboxylic acids, especially dicarboxylic acids, or the anhydrides or esters thereof, for example succinic acid, glutaric acid, adipic acid, trimethyladipic acid, suberic acid, azelaic acid, sebacic acid, dodecane-dicarboxylic acid, maleic acid, fumaric acid, dimer fatty acid, phthalic acid, phthalic acid anhydride, isophthalic acid, terephthalic acid, dimethyl terephthalates, hexahydrophthalic acid, trimellitic acid and trimellitic acid anhydride, or mixtures of the aforementioned acids, as well as polyester polyols from lactones, for example from □-caprolactone and starters such as the aforementioned di- or trihydric alcohols.

Particularly suitable polyester polyols are polyester diols.
Poly carbonate polyols such as those that can be obtained for example by reacting the above-mentioned alcohols—used to build up the polyester polyols—with di-alkyl carbonates, diaryl carbonates or phosgene.
Block copolymers having at least two hydroxyl groups and containing at least two different blocks of polyether, polyester and/or polycarbonate structure of the above described type, especially polyether polyester polyols.
Polyacrylate and polymethacrylate polyols.
Polyhydroxyfunctional fats and oils, for example natural fats and oils, especially castor oil, or polyols obtained by chemical modification of natural fats and oils—so-called oleochemical polyols, for example the epoxy polyesters or epoxy polyethers obtained by epoxidation of unsaturated oils and subsequent ring opening with carboxylic acids or alcohols or polyols obtained by hydroformylation and hydrogenation of unsaturated oils, or from natural fats and oils by degradation processes such as alcoholysis or ozonolysis and subsequent chemical combination, for example by transesterification or dimerization of the degradation products or derivatives thereof. Suitable degradation products of natural fats and oils are especially fatty acids and fatty alcohols as well as fatty acid esters, especially the methyl esters (FAME), which can be derivatized for example by hydroformylation and hydrogenation to form hydroxy-fatty acid esters.
Polyhydrocarbon polyols, also called oligohydrocarbonols, for example polyhydroxy functional polyolefins, polyisobutylenes, polyisoprenes; polyhydroxy functional ethylene-propylene-, ethylene-butylene- or ethylene-propylene-diene copolymers, for example those produced by the Kraton Polymers company; polyhydroxy functional polymers of dienes, especially of 1,3-butadiene, which especially can also be produced from anionic polymerization; polyhydroxyfunctional copolymers from dienes such as 1,3-butadiene or diene mixtures and vinyl monomers such as styrene, acrylonitrile, vinyl chloride, vinyl acetate, vinyl alcohol, isobutylene and isoprene, for example polyhydroxy functional acrylonitrile/butadiene copolymers, such as those that can be produced from epoxides or amino alcohols and carboxyl-terminated acrylonitrile/butadiene copolymers (commercially available for example under the names of Hypro® (previously Hycar) CTBN and CTBNX and ETBN from Nanoresins AG, Germany, or Emerald Performance Materials LLC); as well as hydrogenated polyhydroxy functional polymers or copolymers of dienes.

These polyols mentioned preferably have a mean molecular weight of 500-20,000 g/mol and a mean OH functionality in the range of 1.6 to 4.

Polyols preferred as constituents of the first component are polyether polyols, especially polyoxypropylene polyols and polyoxyethylene-polyoxypropylene mixed polyols, as well as polyester polyols and poly carbonate polyols. Particularly preferred are the polyether polyols, especially the polyoxyethylene-polyoxypropylene mixed polyols.

Preferably the polyol has a mean molecular weight of 500-20,000 g/mol, particularly preferably of 1,000-10,000 g/mol, especially of 3,000 to 8,000 g/mol.

Particularly preferably the polyol has a mean functionality of 1.6 to 3, particularly preferably of 1.8 to 3, especially of 2.2 to 3.

Preferably the polyol has primary hydroxyl groups. Primary hydroxyl groups are particularly reactive with isocyanates.

The polyol is preferably present in a quantity of 10 to 90 wt-%, preferably 20 to 80 wt-%, based on the total weight of the first component.

Suitable polyisocyanates as constituents of the second component are especially monomeric di- or triisocyanates, as well as oligomers, polymers and derivatives of the monomeric di- or triisocyanates, as well as any mixtures thereof.

Suitable aromatic monomeric di- or triisocyanates are especially 2,4- and 2,6-toluylenediisocyanate and any mixtures of these isomers (TDI), 4,4′-, 2,4′- and 2,2′-diphenylmethane-diisocyanate and any mixtures of these isomers (MDI), mixtures of MDI and MDI homologs (polymeric MDI or PMDI), 1,3- and 1,4-phenylene-diisocyanate, 2,3,5,6-tetramethyl-1,4-diisocyanatobenzene, naphthalene-1,5-diisocyanate (NDI), 3,3′-dimethyl-4,4′-diisocyanato diphenyl (TODI), dianisidine diisocyanate (DADI), 1,3,5-tris-(isocyana-tomethyl)benzene, tris-(4-isocyanatophenyl)methane and tris-(4-isocyanatophenyl)-thiophosphate.

Suitable aliphatic monomeric di- or triisocyanates are especially 1,4-tetramethylene diisocyanate, 2-methylpentamethylene-1,5-diisocyanate, 1,6-hexamethylene diisocyanate (HDI), 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane-1,3- and -1,4-diisocyanate, 1-methyl-2,4- and -2,6-diisocyanato-cyclohexane and any mixtures of these isomers (HTDI or H₆TDI), 1-isocyanato-3,3,5-trimethyl-5-isocyanatomethyl-cyclohexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis-(isocyanatomethyl)cyclohexane, m- and p-xylylene diisocyanate (m- and p-XDI), m- and p-tetramethyl-1,3- and -1,4-xylylene diisocyanate (m- and p-TMXDI), bis-(1-isocyanato-1-methylethyl)naphthalene, dimer and trimer fatty acid isocyanates such as 3,6-bis-(9-isocyanatononyl)-4,5-di-(1-heptenyl)-cyclohexene (dimeryldiisocyanate) and α,α,α′,α′,α″,α″-hexamethyl-1,3,5-mesitylene triisocyanate. Preferred among these are MDI, TDI, HDI and IPDI.

Suitable oligomers, polymers and derivatives of the monomeric di- and triisocyanates mentioned in particular are derived from MDI, TDI, HDI and IPDI. Among these, especially suitable are commercially available types, especially HDI-biurets such as Desmodur® N 100 and N 3200 (from Bayer), Tolonate® HDB and HDB-LV (from Rhodia) and Duranate® 24A-100 (from Asahi Kasei); HDI isocyanurates, such as Desmodur® N 3300, N 3600 and N 3790 BA (all from Bayer), Tolonate® HDT, HDT-LV and HDT-LV2 (from Rhodia), Duranate® TPA-100 and THA-100 (from Asahi Kasei) and Coronate® HX (from Nippon Polyurethane); HDI-uretdiones such as Desmodur® N 3400 (from Bayer); HDI-iminooxadiazine diones such as Desmodur® XP 2410 (from Bayer); HDI-allophanates such as Desmodur® VP LS 2102 (from Bayer); IPDI isocyanurates, for example in solution as Desmodur® Z 4470 (from Bayer) or in solid form as Vestanat® T1890/100 (from Degussa); TDI oligomers such as Desmodur® IL (from Bayer); as well as mixed isocyanurates based on TDI/HDI, for example as Desmodur® HL (from Bayer). Furthermore especially suitable are forms of MDI liquid at room temperature (so-called “modified MDI”), which represent mixtures of MDI with MDI derivatives, such as especially MDI-carbodiimides or MDI-uretoneimines or MDI-urethanes, known under trade names such as Desmodur® CD, Desmodur® PF, Desmodur® PC (all from Bayer) or Isonate® M 143 (from Dow), as well as mixtures of MDI and MDI homologs (polymeric MDI or PMDI), available under trade names such as Desmodur® VL, Desmodur® VL50, Desmodur® VL R10, Desmodur® VL R20, Desmodur® VH 20 N and Desmodur® VKS 20F (all from Bayer), Isonate® M 309, Voranate® M 229 and Voranate® M 580 (all from Dow) or Lupranat® M 10 R (from BASF). In practice, the aforementioned oligomeric polyisocyanates are usually mixtures of substances with different degrees of oligomerization and/or chemical structures. Preferably they have a mean NCO-functionality of 2.1 to 4.0.

In addition, suitable polyisocyanates as constituents of the second component are especially isocyanate group-containing polyurethane polymers obtainable by reacting at least one polyol with at least one polyisocyanate, in which suitable polyols are the polyols previously mentioned as constituents of the first component and suitable polyisocyanates are the previously mentioned monomeric di- or triisocyanates, especially MDI, TDI, IPDI and HDI. Preferred polyols are polyether, polyester, polycarbonate and polyacrylate polyols, especially the di- and triols. Particularly preferred among these are polyether polyols, especially polyoxypropylene polyols and polyoxypropylene-polyoxyethylene polyols, as well as polyester polyols and polyether polyester polyols that are liquid at room temperature.

The reaction be carried out in that the polyol and the polyisocyanate are reacted by the usual methods, for example at temperatures of 50° C. to 100° C., optionally using suitable catalysts, wherein the amount of polyisocyanate added is such that the isocyanate groups thereof are present in stoichiometric excess relative to the hydroxyl groups of the polyol and wherein the excess polyisocyanate monomer remaining after the reaction may optionally be removed completely or partially, for example by distillation or extraction. Advantageously the polyisocyanate is added in a quantity such that a NCO/OH ratio of 1.3 to 20, especially 1.5 to 10, is maintained. The term “NCO/OH ratio” means the ratio of the number of isocyanate groups used to the number of hydroxyl groups used.

Preferably, after reaction of all hydroxyl groups, a free isocyanate group content of 0.5 to 30, especially 1 to 25, wt-% remains in the isocyanate group-containing polyurethane polymer.

Optionally the isocyanate group-containing polyurethane polymer can be produced with the aid of plasticizers that contain no groups reactive toward isocyanates.

Preferably the polyisocyanate is selected from the group consisting of MDI, TDI, HDI and IPDI, oligomers, polymers and derivatives of the isocyanate- and isocyanate group-containing polyurethane polymers based on the isocyanates mentioned as well as mixtures thereof.

Preferably, the polyisocyanate contains isocyanurate, iminooxadiazinedione, uretdione, urethane, biuret, allophanate, carbodiimide, uretoneimine or oxadiazinetrione groups.

Particularly preferred as constituents of the second component are polyisocyanates in the form of oligomeric polyisocyanates, especially biurets, isocyanurates, uretdiones and allophanates of HDI, IPDI and TDI, mixtures of MDI with MDI carbodiimides, MDI uretoneimines or MDI urethanes, as well as polymeric MDI. Using these polyisocyanates, cured compositions with particularly high strengths are obtained.

Additional, particularly preferred constituents of the second component are polyurethane polymers in the form of isocyanate group-containing polyisocyanates. Cured compositions with particularly high elasticity are obtained with isocyanate group-containing polyurethane polymers.

Furthermore particularly preferred as constituents of the second component are polyisocyanates in the form of mixtures of at least one isocyanate group-containing polyurethane polymer and at least one oligomeric polyisocyanate. The strength and elasticity of the cured compositions can be well adapted to the demands mentioned.

Most preferably the polyisocyanate is an aromatic polyisocyanate, especially a form of MDI that is liquid at room temperature. These are especially so-called polymeric MDI as well as MDI with fractions of oligomers or derivatives thereof. Particularly good processing properties and particularly high strengths are obtained with these.

To obtain compositions with very high strength and good elasticity it may be advantageous if the second component contains a combination of a form of MDI that is liquid at room temperature and an isocyanate group-containing polyurethane polymer.

In one embodiment of the invention the polyisocyanate does not exist in free form at room temperature, but rather as a surface-deactivated polyisocyanate that is solid at room temperature. This is based on a polyisocyanate, solid at room temperature, the melting point of which is distinctly above room temperature, especially the commercially available, fine particulate uretdione of 2,4-toluylene diisocyanate, for example as Addolink® TT (from Rhein Chemie).

The polyisocyanate, solid at room temperature, is additionally surface-deactivated by reacting it with a substance having at least one group reactive with isocyanate groups, for example with a primary polyamine. In this way a protective surface that is stable at room temperature or slightly above, i.e., is impermeable and largely insoluble, is formed. When the surface-deactivated polyisocyanate is heated to a temperature of especially at least 80° C., the layer on the polyisocyanate particles is damaged to such an extent that the isocyanate groups in the interior of the particles become accessible to chemical reaction partners, and thus they are “activated.”

Preferably the isocyanate groups of the polyisocyanates exist in free form.

Furthermore the composition includes at least one blocked amine Z, which has an oxazolidino group or an aldimino group as well as at least one additional reactive group selected from the group consisting of oxazolidino groups, aldimino groups, hydroxyl groups, mercapto groups, primary amino groups, secondary amino groups and isocyanate groups.

The blocked amine Z is typically liquid at room temperature. Therefore it can be easily incorporated into the composition without the use of solvents.

The blocked amine Z can be present as a constituent of the first component or as a constituent of the second component.

A blocked amine Z with hydroxyl groups or mercapto groups or primary or secondary amino groups is especially suitable as a constituent of the first component. If it is used as a constituent of the second component, it can react with isocyanate groups present, finally resulting in a higher-molecular-weight, isocyanate group-containing blocked amine Z.

A blocked amine Z with isocyanate groups is especially suitable as a constituent of the second component. If it is used as a constituent of the first component, it can react with available hydroxyl groups, finally resulting in a higher-molecular-weight, hydroxyl group-containing blocked amine Z.

Especially suitable blocked amines Z with oxazolidino groups are condensation products of diethanolamine with aldehydes or ketones, forming N-(2-hydroxy-ethyl)-tetrahydrooxazoles. Preferably these are then converted with the aid of diisocyanates, especially HDI, or with the aid of diesters or carbonates, to bis-oxazolidines. Hydrolytic activation can liberate both a secondary amino group and a hydroxyl group from each oxazolidino group. Especially suitable commercial oxazolidines are Harter OZ (from Bayer), Zoldine® RD-4 (from Angus Chemical), as well as Incozol® 3, Incozol® LV, Incozol® 4, Incozol® HP, Incozol® NC, Incozol® CF, Incozol® EH and Incozol® K (from Incorez).

Suitable blocked amines Z with aldimino groups are condensation products of primary amines with aldehydes. A primary amino group can be liberated from each aldimino group by hydrolytic activation.

In one embodiment, suitable primary amines for producing them are amines with at least two primary amino groups. Blocked amines Z with at least two aldimino groups can be obtained from stoichiometric reaction with aldehydes. In another embodiment, suitable primary amines for producing them are amines with at least one primary amino group and with additionally at least one hydroxyl group or mercapto group or secondary amino group.

A blocked amine Z with at least one aldimino group preferably is based on an amine selected from the group consisting of 1,6-hexamethylene diamine, 1,5-diamino-2-methyl pentane, 1,3-pentane diamine, 1-amino-3-aminomethyl-3,5,5-trimethylcyclohexane (=isophorone diamine), 2,2,4- and 2,4,4-trimethylhexamethylene diamine, 1,3-bis-(aminomethyl)-benzene, 1,3-bis-(aminomethyl)-cyclohexane, 1,4-bis-(aminomethyl)-cyclohexane, bis-(4-aminocyclohexyl)-methane, bis-(4-amino-3-methylcyclohexyl)-methane, 3(4), 8(9)-bis-(aminomethyl)-tricyclo[5.2.1.0^{2,6}]decane, 1,2-, 1,3- and 1,4-diaminocyclohexane, 1,4-diamino-2,2,6-trimethyl-cyclohexane, 3,6-dioxaoctane-1,8-diamine, 4,7-dioxadecane-1,10-diamine, 4-aminomethyl-1,8-octane diamine, polyoxyalkylene polyamines with two or three amino groups and a molecular weight of up to 600 g/mol, especially the types, commercially available under the trade name of Jeffamine® D-230, D-400 and T-403 from Huntsman and analogous compounds from BASF or Nitroil; 1,3- and 1,4-phenylenediamine, 2,4- and 2,6-toluylene-diamine, 4,4′-, 2,4′- and 2,2′-diamino-diphenylmethane, 3,3′-dichloro-4,4′-diamino-diphenylmethane, 5-amino-1-pentanol, 6-amino-1-hexanol, 4-(2-aminoethyl)-2-hydroxy ethylbenzene, 3-aminomethyl-3,5,5-trimethyl-cyclohexanol, 2-(2-aminoethoxy)-ethanol, triethylene glycol-monoamine, 3-(2-hydroxy-ethoxy)-propylamine, 3-(2-(2-hydroxy-ethoxy)-ethoxy)propylamine and 3-(6-hydroxy-hexyloxy)-propylamine, N-methyl-1,2-ethanediamine, N-ethyl-1,2-ethanediamine, N-cyclohexyl-1,2-ethanediamine, N-methyl-1,3-propanediamine, N-ethyl-1,3-propanediamine, N-butyl-1,3-propanediamine, N-cyclohexyl-1,3-propanediamine, 4-aminomethyl-piperidine, 3-(4-aminobutyl)-piperidine, N-cocoalkyl-1,3-propane diamine, N-oleyl-1,3-propane diamine, N-soyaalkyl-1,3-propanediamine, and N-tallow alkyl-1,3-propanediamine. These amines are particularly readily accessible and particularly compatible in polyurethane systems.

Preferably the blocked amine Z is free from primary amino groups; in particular it is free from secondary and primary amino groups. Such blocked amines Z have moderate reactivity toward isocyanate groups on contact with moisture.

Particularly preferably the blocked amine Z has at least one aldimino group that cannot be converted to an enamino group by tautomerization. Such aldimino groups have no hydrogen atom on the carbon atom in a-position relative to the carbon atom of the aldimino group. These aldimino groups hydrolyze particularly slowly and are particularly storage-stable together with isocyanates under exclusion of moisture. They are also especially storage-stable with aromatic isocyanates. They are derived from aldehydes which do not have a hydrogen atom on the carbon atom in a-position to the carbon atom of the aldehyde group.

In particular the blocked amine Z has on the aldimino group a radical selected from the group consisting of phenyl, 2,2-dimethylpropyl, 2,2-dimethyl-3-phenylpropyl, 2,2-dimethyl-3-acetoxypropyl, 2,2-dimethyl-3-isobutyroxypropyl, 2,2-dimethyl-3-caproyloxypropyl, 2,2-dimethyl-3-benzoyloxypropyl, 2,2-dimethyl-3-capryloyloxypropyl, 2,2-dimethyl-3-caprinoyloxypropyl, 2,2-dimethyl-3-lauroyloxypropyl, 2,2-dimethyl-3-myristoyloxypropyl, 2,2-dimethyl-3-palmitoyloxypropyl, 2,2-dimethyl-3-stearoyloxypropyl, 2,2-dimethyl-3-dimethylaminopropyl, 2,2-dimethyl-3-diethylaminopropyl, 2,2-dimethyl-3-dibutylaminopropyl, 2,2-dimethyl-3-(N-pyrrolidino)propyl, 2,2-dimethyl-3-(N-piperidino)propyl, 2,2-dimethyl-3-(N-morpholino)propyl, 2,2-dimethyl-3-(N-(2,6-dimethyl)morpholino)propyl, 2,2-dimethyl-3-(N-(4-methylpiperazino))propyl, 2,2-dimethyl-3-(N-(4-ethylpiperazino))propyl, 2,2-dimethyl-3-(N-benzylmethylamino)propyl, 2,2-dimethyl-3-(N-benzylisopropylamino)-propyl, 2,2-dimethyl-3-(N-methylcyclohexylamino)propyl, 2,2-dimethyl-3-bis-(2-methoxy-ethyl)amino-propyl, 2,2-dimethyl-3-bis-(2-hydroxyethyl)aminopropyl and 2,2-dimethyl-3-bis-(2-hydroxypropyl)aminopropyl. Blocked amines Z with such aldimino groups are readily accessible and highly compatible in polyurethane systems.

Particularly preferred among these are 2,2-dimethyl-3-caproyloxypropyl, 2,2-dimethyl-3-benzoyloxypropyl, 2,2-dimethyl-3-capryloyloxypropyl, 2,2-dimethyl-3-caprinoyloxypropyl, 2,2-dimethyl-3-lauroyloxypropyl, 2,2-dimethyl-3-myristoyloxypropyl, 2,2-dimethyl-3-palmitoyloxypropyl, 2,2-dimethyl-3-stearoyloxypropyl, 2,2-dimethyl-3-(N-morpholino)propyl, 2,2-dimethyl-3-(N-(2,6-dimethyl)morpholino)propyl, 2,2-dimethyl-3-(N-(4-ethylpiperazino))propyl, 2,2-dimethyl-3-(N-(4-ethylpiperazino))propyl, 2,2-dimethyl-3-(N-benzylmethylamino)propyl, 2,2-dimethyl-3-(N-benzylisopropylamino)propyl, 2,2-dimethyl-3-bis-(2-methoxyethyl)amino-propyl, 2,2-dimethyl-3-bis-(2-hydroxyethyl)-aminopropyl and 2,2-dimethyl-3-bis-(2-hydroxy-2-methylethyl)aminopropyl, especially 2,2-dimethyl-3-lauroyloxypropyl and 2,2-dimethyl-3-(N-morpholino)propyl.

Blocked amines Z with these aldimino groups are low-odor or odorless. They have the advantage that low-odor or odorless aldehydes are released when they are hydrolyzed, and these also largely remain in the composition even after being liberated, thus do not diffuse into the environment. For this reason, compositions containing such blocked amines Z are also especially suitable for applications in closed rooms.

Particularly preferred in one aspect of the invention are 2,2-dimethyl-3-bis-(2-hydroxyethyl)aminopropyl and 2,2-dimethyl-3-bis-(2-hydroxy-2-methylethyl)aminopropyl. These radicals each have two hydroxyl groups. Blocked amines Z with these aldimino groups release aldehydes during their hydrolysis and reaction with isocyanate groups that contain two hydroxyl groups, so that they can be incorporated into the polymer during curing of the composition, which can be highly advantageous.

Particularly preferred blocked amines Z are selected from the group consisting of N,N′-bis-(2,2-dimethyl-3-lauroyloxypropylidene)-1,6-hexamethylene-diamine, N,N′-bis-(2,2-dimethyl-3-acetoxypropylidene)-1,6-hexamethylene-diamine, N,N′-bis-(2,2-dimethyl-3-(N-morpholino)-propylidene)-1,6-hexamethylene-diamine, N,N′-bis-(2,2-dimethyl-3-phenylpropylidene)-1,6-hexamethylene-diamine, N,N′-bis-(2,2-dimethyl-3-bis-(2-hydroxyethyl)-aminopropylidene)-1,6-hexamethylene-diamine, N,N′-bis-(2,2-dimethyl-3-bis-(2-hydroxypropyl)aminopropylidene)-1,6-hexamethylene-diamine, N,N′-bis-(2,2-dimethyl-3-lauroyloxypropylidene)-1-amino-3-aminomethyl-3,5,5-trimethylcyclohexane, N,N′-bis-(2,2-dimethyl-3-acetoxypropylidene)-1-amino-3-aminomethyl-3,5,5-trimethylcyclohexane, N,N′-bis-(2,2-dimethyl-3-(N-morpholino)-propylidene)-1-amino-3-aminomethyl-3,5,5-trimethyl-cyclohexane, N,N′-bis-(2,2-dimethyl-3-phenylpropylidene)-1-amino-3-aminomethyl-3,5,5-trimethylcyclohexane, N,N′-bis-(2,2-dimethyl-3-bis-(2-hydroxyethyl)aminopropylidene)-1-amino-3-aminomethyl-3,5,5-trimethylcyclohexane, N,N′-bis-(2,2-dimethyl-3-bis-(2-hydroxypropyl)aminopropylidene)-1-amino-3-aminomethyl-3,5,5-trimethylcyclohexane, N,N′-bis-(2,2-dimethyl-3-lauroyloxypropylidene)-polyoxypropylene-diamine, N,N′-bis-(2,2-dimethyl-3-acetoxypropylidene)-polyoxypropylene-diamine, N,N′-bis-(2,2-dimethyl-3-(N-morpholino)-propylidene)-polyoxypropylene-diamine, N,N′-bis-(2,2-dimethyl-3-bis-(2-hydroxyethyl)aminopropylidene)-polyoxypropylene-diamine, N,N′-bis-(2,2-dimethyl-3-bis-(2-hydroxypropyl)aminopropylidene)-polyoxypropylene-diamine, N,N′,N″-tris(2,2-dimethyl-3-lauroyloxypropylidene)-polyoxypropylene-triamine, N,N′,N″-tris(2,2-dimethyl-3-acetoxypropylidene)-polyoxypropylene-triamine, N,N′,N″-tris(2,2-dimethyl-3-(N-morpholino)-propylidene)-polyoxypropylenetriamin, N,N′,N″-tris(2,2-dimethyl-3-bis-(2-hydroxyethyl)aminopropylidene)-polyoxypropylene-triamine, N,N′,N″-tris(2,2-dimethyl-3-bis-(2-hydroxypropyl)aminopropylidene)-polyoxypropylen-triamine, N-2,2-dimethyl-3-lauroyloxypropylidene-2-(2-aminoethoxyl)ethanol, N-2,2-dimethyl-3-acetoxypropylidene-2-(2-aminoethoxy)ethanol and N-2,2-dimethyl-3-(N-morpholino)-propylidene-2-(2-amino-ethoxy)ethanol.

The composition also comprises at least one catalyst K selected from the group consisting of bismuth(III) compounds and zirconium(IV) compounds.

The catalyst K can be present as a constituent of the first and/or of the second component.

The catalyst K can be used as a powder, a liquid or a solution.

Particularly suitable catalysts K are bismuth(III) complexes and zirconium(IV) complexes. Compared with other compounds of these metals, complexes are more stable against hydrolysis, so that the complexes largely retain their catalytic activity even in the presence of water.

Bismuth(III) complexes and zirconium(IV) complexes can be produced by known methods starting from, for example, bismuth(III)-oxide or zirconium(IV)-oxide.

Especially suitable ligands of bismuth(III) complexes and zirconium(IV) complexes are
Alcoholates, especially methanolate, ethanolate, propanolate, isopropanolate, butanolate, tert-butanolate, isobutanolate, pentanolate, neopentanolate, hexanolate and octanolate;
Carboxylates, especially formate, acetate, propionate, butanoate, isobutanoate, pentanoate, hexanoate, cyclohexanoate, heptanoate, octanoate, 2-ethylhexanoate, nonanoate, decanoate, neodecanoate, undecanoate, dodecanoate, lactate, oleate, citrate, benzoate, salicylate and phenylacetate;
1,3-Diketonates, especially acetylacetonate (2,4-pentanedionate), 2,2,6,6-tetramethyl-3,5-heptanedionate, 1,3-diphenyl-1,3-propanedionate (dibenzoylmethanate), 1-phenyl-1,3-butananedionate and 2-acetylcyclohexanonate;
Oxinate;
1,3-Ketoesterates, especially methyl acetoacetate, ethyl acetoacetate, ethyl-2-methyl acetoacetate, ethyl-2-ethyl acetoacetate, ethyl-2-hexylacetoacetate, ethyl-2-phenyl-acetoacetate, propyl acetoacetate, isopropyl acetoacetate, butyl acetoacetate, tert-butyl acetoacetate, ethyl-3-oxo-valerate, ethyl-3-oxo-hexanoate and 2-oxo-cyclohexane carboxylic acid ethyl esterate; and
1,3-Ketoamidates, especially N,N-diethyl-3-oxo-butanamidate, N,N-dibutyl-3-oxo-butanamidate, N,N-bis-(2-ethylhexyl)-3-oxo-butanamidate, N,N-bis-(2-methoxyethyl)-3-oxo-butanamidate, N,N-dibutyl-3-oxo-heptanamidate, N,N-bis-(2-methoxyethyl)-3-oxo-heptanamidate, N,N-bis-(2-ethylhexyl)-2-oxo-cyclopentane carboxamidate, N,N-dibutyl-3-oxo-3-phenylpropanamidate, N,N-bis-(2-methoxyethyl)-3-oxo-3-phenylpropanamidate and N-polyoxyalkylene-1,3-ketoamidates such as especially acetoamidates of polyoxyalkyleneamines with one, two or three amino groups and a molecular weight of up to 5000 g/mol, especially the types available from Huntsman under the trade names of Jeffamine® SD-231, SD-401, SD-2001, ST-404, D-230, D-400, D-2000, T-403, M-600 and XTJ-581.

The catalyst K produces rapid curing in the composition, proceeding with surprisingly few problems; in particular, bubbles occur less frequently than with other catalysts according to the prior art. In addition, the catalyst K affects the composition surprisingly so that after curing it has a higher strength, especially a higher modulus of elasticity, than when other catalysts according to the prior art are used, for example 1,4-diazabicyclo[2.2.2]octane (DABCO), or dibutyltin dilaurate.

The catalyst K is especially present in the composition in a quantity such that after the mixing of the first and second components the composition has an open time in the range of 1 minute to 2 hours, preferably 2 minutes to 1 hour, particularly preferably 5 to 30 minutes. The open time of the composition is affected by the type of catalyst K, the polyols, polyisocyanates, blocked amines Z and other substances reactive with isocyanates, as well as by the availability of water in the composition and the prevailing temperature.

The catalyst K particularly preferably has at least one ligand selected from the group consisting of alcoholates, carboxylates, 1,3-diketonates, 1,3-ketoesterates, oxinates and 1,3-ketoamidates. These ligands form stable complexes with bismuth(III) and zirconium(IV).

Particularly preferably the catalyst K has at least one ligand selected from the group consisting of 1,3-diketonates, 1,3-ketoesterates, oxinates and 1,3-ketoamidates. These ligands form chelate complexes with bismuth(III) and zirconium(IV). In addition to at least one of the chelate-ligands mentioned, the catalyst K can additionally contain ligands that do not form chelates, especially the alcoholates and carboxylates mentioned. Such chelate complexes are particularly stable against hydrolysis.

Particularly preferred as the catalyst K are zirconium(IV) complexes. Zirconium(IV) complexes are particularly storage-stable in the presence of polyisocyanates. As a result they are particularly suitable for use as constituents of the second component. This is particularly advantageous if the composition contains added water as a constituent of the first component. Furthermore zirconium(IV) complexes accelerate the curing of the composition particularly well and yield particularly high strengths after curing.

Preferably the zirconium(IV) complex is present in a quantity such that the number of milliequivalents of zirconium relative to the number of NCO equivalents in the composition is in the range of 0.05 to 50, preferably 0.1 to 20, especially 0.2 to 10.

Particularly preferred zirconium(IV) complexes are selected from the group consisting of zirconium(IV)-tetrakis(acetate), zirconium(IV)-tetrakis(octanoate), zirconium(IV)-tetrakis(2-ethylhexanoate), zirconium(IV)-tetrakis(neodecanoate), zirconium(IV)-tetrakis(acetylacetonate), zirconium(IV)-tetrakis(1,3-diphenylpropane-1,3-dionate), zirconium(IV)-tetrakis(ethyl acetoacetate), zirconium(IV)-tetrakis(N,N-diethyl-3-oxo-butanamidate) and zirconium(IV) complexes with various ones of these ligands mentioned.

In another embodiment the preferred catalysts K are bismuth(III) complexes. Bismuth(III) complexes are particularly stable toward hydrolysis.

Preferably the bismuth(III) complex is present in such a quantity, that the number of milliequivalents of bismuth relative to the number of NCO equivalents in the composition is in the range of 0.01 to 20, preferably 0.05 to 5, especially 0.1 to 3.

Particularly preferred bismuth(III) complexes are selected from the group consisting of bismuth(III)-tris(acetate), bismuth(III)-tris(octanoate), bismuth(III)-tris(2-ethylhexanoate), bismuth(III)-tris(neodecanoate), bismuth(III)-bis-(neodecanoate-oxinate, bismuth(III)-neodecanoate-bis-(oxinate), bismuth(III)-tris-(N,N-diethyl-3-oxo-butanamidate) and bismuth(III) complexes with various ones of these ligands mentioned.

In addition, as a constituent of the first component the composition can also contain at least one diol with two primary hydroxyl groups and a molecular weight in the range of 60 to 150 g/mol. Such diols are also designated as chain extenders. The diol forms so-called hard segments with the polyisocyanate in the cured material. It makes possible cured compositions with high strengths.

Suitable diols are especially 1,2-ethanediol, 1,3-propanediol, 1,4-butanediol, 1,5-pentanediol, 1,6-hexanediol, 1,4-cyclohexanedimethanol and diethylene glycol. These diols are readily obtainable and have primary hydroxy-groups with very little steric hindrance, which are particularly reactive with isocyanate groups.

Preferred among these are 1,3-propanediol, 1,4-butanediol and 1,5-pentanediol. These diols are linear and thus yield particularly high strengths. In addition they are particularly manageable, since they are scarcely hydrophilic and are liquid at room temperature.

Preferably the diol is present in the first component in a quantity such that the ratio of the number of OH groups of the diol to the number of OH groups of the polyols is in the range of 1 to 50, preferably 2 to 20, especially 2 to 10.

Preferably the blocked amine Z is present in the composition in a quantity such that the number of its reactive groups, including blocked amino groups, relative to the number of OH groups of the polyol and additional alcohols optionally present in the composition is in the range of 0.01 to 10, preferably 0.02 to 5, particularly preferably 0.05 to 2, and most preferably 0.1 to 1. Oxazolidino groups in such cases are counted as two groups reactive toward isocyanate groups.

Catalyst selection is of decisive importance for achieving the correct balance between the reactivity of the hydroxyl groups and the reactivity of the hydrolyzing groups of the blocked amine Z. Surprisingly it was found that in the presence of bismuth(III) and/or zirconium(IV) compounds the hydrolyzing blocked amine Z is incorporated into the curing polymer made from polyisocyanate and polyol, increased strength of the cured composition results, whereas with other catalysts customarily used in polyurethane systems, such as DABCO, dibutyltin dilaurate, tin(II)-octoate or titanates, increased strength is not observed due to the blocked amine Z, but on the contrary, distinctly lower strengths often result.

After the first and second components are mixed, the hydroxyl groups, mercapto groups and primary and secondary amino groups present react with the isocyanate groups present. The blocked, hydrolytically activatable amino groups of the blocked amine Z react with the isocyanate groups present as soon as they come into contact. The water needed for hydrolysis of the blocked amino groups can at least partially be already present in the composition, or it diffuses from the outside in the form of moisture from the environment, especially in the form of humidity, into the mixed, applied composition.

As constituents of the first component the composition preferably additionally contains water or a water-generating substance, especially in a quantity such that the ratio between the number of water molecules and the number of blocked amino groups is greater than 0.25, preferably at least 0.5. A composition of this type has particularly high strength after curing.

Water can enter the composition either in the form of residual moisture with substances present in the first component such as especially polyols, fillers, plasticizers or cross-linking agents, or it is added to the composition, either as a constituent of the first component or during the mixing of the two components or during the application of the mixed composition.

Water can either be present in free form, or it may be bound to a carrier material. The binding to a carrier material that may be present is reversible, in other words, the water is available for reaction with the blocked amine Z.

Suitable carrier materials for water are porous materials that enclose water in cavities, especially diatomaceous earth and molecular sieves. Other suitable carrier materials are those that take up water in nonstoichiometric quantities and have a pasty consistency or form gels, for example silica gels, clays, polysaccharides or polyacrylic acids, which are also known under the name of “super-absorbers” and are used, for example, in the production of hygiene articles. Additional suitable carrier materials are polymers, in which water can be emulsified in such a manner that a stable emulsion results. Furthermore suitable are hydrates and aqua complexes, especially inorganic compounds, which contain water coordinatively bound or as water of crystallization.

For cases in which the composition additionally contains water in the first component, blocked amines Z with aldimino groups are preferred constituents of the first component. Aldimines usually do not hydrolyze spontaneously in the presence of water, but only if the mixture of water and aldimine is contacted with isocyanates; in this case the hydrolyzing aldimino groups react with the isocyanate groups. The moderate reaction rate of aldimines with isocyanates is thus also true even if the aldimines were already in contact with water before.

In cases in which the composition contains a blocked amine Z with oxazolidino groups and water is additionally present in the first component, the oxazolidine is preferably a constituent of the second component, since in the presence of water oxazolidines usually hydrolyze spontaneously to the corresponding amino alcohols and therefore exhibit high reactivity toward isocyanates, reducing the open time.

In a composition that additionally contains water or a water generating substance as a constituent of the first component, the catalyst K is preferably a constituent of the second component. In this case the catalyst cannot be deactivated by hydrolysis processes before mixing the composition.

As constituents of the first component the composition can additionally contain other substances reactive with isocyanate groups.

In particular the first component can contain small amounts of primary amines, especially to obtain a structurally viscous, less strongly flowing or slipping away material immediately upon mixing of the two components. Especially suitable primary amines for this purpose are aliphatic polyamines such as ethylenediamine, 1,2-propanediamine, 1,3-propanediamine, 2-methyl-1,2-propanediamine, 2,2-dimethyl-1,3-propanediamine, 1,3-butanediamine, 1,4-butanediamine, 1,3-pentanediamin (DAMP), 1,5-pentanediamine, 1,5-diamino-2-methylpentane, 2-butyl-2-ethyl-1,5-pentanediamine (C11-neodiamine), 1,6-hexanediamine, 2,5-dimethyl-1,6-hexanediamine, 2,2,4- and 2,4,4-trimethylhexamethylene-diamine (TMD), 1,7-heptanediamine, 1,8-octanediamine, 1,9-nonanediamine, 1,10-decane-diamine, 1,11-undecanediamine, 1,12-dodecanediamine, 1,2-, 1,3- and 1,4-diaminocyclohexane, 1,4-diamino-2,2,6-trimethylcyclohexane (TMCDA), bis-(4-aminocyclohexyl)-methane (H₁₂-MDA), bis-(4-amino-3-methylcyclohexyl)-methane, bis-(4-amino-3-ethylcyclohexyl)-methane, bis-(4-amino-3,5-dimethylcyclohexyl)-methane, bis-(4-amino-3-ethyl-5-methylcyclohexyl)-methane (M-MECA), 1-amino-3-aminomethyl-3,5,5-trimethylcyclohexane (=isophorone diamine or IPDA), 2- and 4-methyl-1,3-diaminocyclohexane and mixtures thereof, 1,3- and 1,4-bis-(aminomethyl)cyclohexane, 2,5(2,6)-bis-(aminomethyl)-bicyclo[2.2.1]heptane (NBDA), 3 (4), 8(9)-bis-(aminomethyl)-tricyclo[5.2.1.0^{2,6}]decane, 1,8-menthanediamine and 1,3- and 1,4-bis-(aminomethyl)benzene, as well as ether group-containing polyamines, especially bis-(2-aminoethyl)ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine and higher oligomers of these polyamines, 3,9-bis-(3-aminopropyl)-2,4,8,10-tetra-oxaspiro[5.5]undecane, bis-(3-aminopropyl)polytetrahydrofurans and other polytetrahydrofuran diamines, Jeffamine® RFD-270 (from Huntsman), as well as short-chain polyoxyalkylene-polyamines, which represent products from the amination of polyoxyalkylene-di- or triols and for example are available under the name of Jeffamine® (from Huntsman), especially Jeffamine® D-230, Jeffamine® D-400 and Jeffamine® T-403.

Particularly suitable ones of these are 1,5-diamino-2-methylpentane, 2,2,4- and 2,4,4-trimethylhexamethylene-diamine, 1,8-octanediamine, 1,10-decane diamine, 1,12-dodecanediamine, 1-amino-3-aminomethyl-3,5,5-trimethylcyclohexane, 2- and 4-methyl-1,3-diaminocyclohexane and mixtures thereof, 1,3-bis-(aminomethyl)cyclohexane, 1,4-bis-(aminomethyl)cyclohexane, 2,5(2,6)-bis-(aminomethyl)-bicyclo[2.2.1]heptane, 3 (4), 8 (9)-bis-(aminomethyl)-tricyclo[5.2.1.0^{2,6}]decane, bis-(2-aminoethyl)ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 1,3-bis-(aminomethyl)benzene, 1,4-bis-(aminomethyl)benzene and the Jeffamines® D-230, D-400 and T-403.

For compositions that are intended to be self-supporting after mixing of the two components, and which have very high strengths in the cured state, 1,3-bis-(aminomethyl)cyclohexane and 1,3-bis-(aminomethyl)benzene, especially 1,3-bis-(aminomethyl)benzene, are highly suitable.

Furthermore the first component can contain low-molecular-weight dihydric or polyhydric alcohols, such as especially 1,2-propanediol, 2-methyl-1,3-propanediol, 2-ethyl-2-methyl-1,3-propanediol, 2-methyl-2-propyl-1,3-propanediol, neopentylglycol, triethylene glycol, the isomeric dipropylene glycols and tripropylene glycols, the isomeric butanediols, the isomeric pentanediols, the isomeric hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher-hydric alcohols and low-molecular-weight alkoxylation products of these alcohols.

In addition to the constituents mentioned, the composition can contain additional constituents usually used in two-component polyurethane compositions, especially the following:
plasticizers, especially carboxylic acid esters such as phthalates, especially dioctyl phthalate, diisononyl phthalate or diisodecyl phthalate, adipates, especially dioctyl adipate, azelates and sebacates, organic phosphorus and sulfonic acid esters or polybutene;
non-reactive thermoplastic polymers, for example homo- or copolymers of unsaturated monomers, especially from the group comprising ethylene, propylene, ethylene-butylene, isobutylene, isoprene, vinyl acetate and alkyl(meth)acrylates, especially polyethylene (PE), polypropylene (PP), polyisobutylene, ethylene-vinyl acetate copolymers (EVA) and atactic poly-a-olefins (APAO);
solvents;
inorganic and organic fillers, especially ground or precipitated calcium carbonates, optionally coated with fatty acids, especially stearates, barite (barium sulfate), talcs, powdered quartz, quartz sand, dolomite, wollastonite, kaolin, mica, aluminum oxides, silicas, especially highly dispersed silicas from pyrolysis processes, cements, gypsums, fly ashes, carbon blacks, especially industrially produced carbon blacks (called “carbon black” in the following), graphite, metal powders, for example powdered aluminum, copper, iron, zinc, silver or steel, powdered PVC or hollow beads;
fibers, for example polyethylene fibers;
pigments, for example titanium dioxide, zinc oxide or iron oxides;
catalysts that accelerate the hydrolysis of the protected amino groups, especially acids, especially organic carboxylic acids such as benzoic acid, salicylic acid or 2-nitrobenzoic acid, organic carboxylic acid anhydrides such as phthalic anhydride, hexahydrophthalic acid anhydride and hexahydromethylphthalic acid anhydride, silyl esters of organic carboxylic acids, organic sulfoxylic acids such as methanesulfonic acid, p-toluenesulfonic acid or 4-dodecylbenzenesulfonic acid, sulfonic acid esters, other organic or inorganic acids, or mixtures of the aforementioned acids and acid esters;
additional catalysts that accelerate the reaction of the isocyanate groups, especially organotin compounds such as dibutyltin diacetate, dibutyltin dilaurate, dibutyltin dichloride, dibutyltin diacetylacetonate and dioctyltin dilaurate; compounds of zinc, manganese, iron, chromium, cobalt, copper, nickel, molybdenum, lead, cadmium, mercury, antimony, vanadium, titanium and potassium, especially zinc(II)-acetate, zinc(II)-2-ethylhexanoate, zinc(II)-laurate, zinc(II)-acetylacetonate, iron(III)-2-ethylhexanoate, Cobalt(II)-2-ethylhexanoate, copper(II)-2-ethylhexanoate, nickel(II)-naphthenate, aluminum lactate, aluminum oleate, diisopropoxytitanium-bis-(ethyl acetoacetate) and potassium acetate; tertiary amino group-containing compounds, especially 2,2′-dimorpholinodiethyl ether, 1,4-diazabicyclo[2.2.2]octane, N-ethyl-diiso-propylamine, N,N,N′,N′-tetramethyl-alkylenediamine, pentamethyl-alkylenetriamine and higher homologs thereof, bis-(N,N-diethylaminoethyl) adipate, tris-(3-dimethyl-aminopropyl)amine, 1,4-diazabicyclo[2.2.2]octane (DABCO), 1,8-diazabicyclo-[5.4.0]undec-7-ene (DBU), 1,5-diazabicyclo[4.3.0]non-5-ene (DBN), N-alkylmorpholines, N,N′-dimethylpiperazine; nitrogenaromatic compounds such as 4-dimethylaminopyridine, N-methylimidazole, N-vinylimidazole or 1,2-dimethylimidazole; organic ammonium compounds such as benzyltrimethylammonium hydroxide or alkoxylated tertiary amines; so-called “delayed action” catalysts, which are modifications of known metal or amine catalyst; as well as combinations of the compounds mentioned, especially of metal compounds and tertiary amines;
rheology modifiers, especially thickeners or thixotropic agents, for example phyllosilicates such as bentonite, derivatives of castor oil, hydrogenated castor oil, polyamides, polyamide waxes, polyurethanes, urea compounds, pyrogenic silicas, cellulose ethers and hydrophobically modified polyoxyethylenes;
drying agents, such as molecular sieves, calcium oxide, highly reactive isocyanates such as p-tosylisocyanate, monomeric diisocyanates, mono-oxazolidines such as Incozol® 2 (from Incorez), orthoformic acid esters, alkoxysilanes such as tetraethoxy-silane, organoalkoxysilanes such as vinyltrimethoxysilane;
adhesion promoters, for example organoalkoxysilanes such as aminosilanes, mercaptosilanes, epoxysilanes, vinylsilanes, (meth)acrylsilanes, isocyanatosilanes, carba-matosilanes, alkylsilanes, S-(alkylcarbonyl)mercaptosilanes and aldiminosilanes, as well as oligomeric forms of these silanes, especially 3-glycidoxypropyl trimethoxysilane, 3-aminopropyltrimethoxysilane, N-(2-aminoethyl)-3-aminopropyl-trimethoxysilane, N-(2-amino ethyl)-N′-[3-(trimethoxysilyl)propyl]ethylenediamine, 3-mercapto propyl-trimethoxysilane, 3-iso cyanatopropyltrimethoxysilane, 3-ureidopropyltrimethoxysilane, 3-chloropropyltrimethoxysilane, vinyltrimethoxysilane, or the corresponding organosilanes with ethoxy groups in place of the methoxy groups;
stabilizers against oxidation, heat, light and UV radiation;
fire-retardant substances, for example aluminum hydroxides, magnesium hydroxide, phosphoric acid esters;

surface-active substances, especially wetting agents, leveling agents, deaerating agents or defoamers;
biocides for example algicides, fungicides or fungal growth-inhibiting substances.

It is advantageous when using additional constituents of the composition to make sure that these do not greatly interfere with the storage stability of the composition. If such substances are stored together with isocyanates, this means that they should contain no water or at most traces of water. It can be expedient to dry certain constituents chemically or physically before mixing into the composition.

Preferably the composition contains at least one of the acids mentioned, especially salicylic acid. Preferably the acid is not present in the same component as the catalyst K.

A preferred composition additionally contains water as constituents of the first component and at least one acid, and the catalyst K is a constituent of the second component.

The first and the second component of the composition are advantageously formulated such that in the mixed composition the ratio between the number of isocyanate groups and the number of groups reactive toward isocyanates—including the blocked amino groups—prior to curing is approximately in the range of 2 to 0.8, preferably 1.4 to 0.9, particularly preferably 1.25 to 1, and especially 1.1 to 1. In this context oxazolidino groups are counted as two groups reactive toward isocyanate groups.

The two components are produced separately from one another, and at least for the second component, under exclusion of moisture. The components are typically stored in individual containers. Additional constituents of the composition can be present as constituents of the first or of the second component, wherein additional constituents reactive toward isocyanate groups are preferably constituents of the first component. A suitable container for storing the respective component is especially a drum, a hobbock, a bag, a bucket, a canister, cartridge or a tube. The components are suitable for storage, in other words, before use they can be stored for several months to one year or longer without their respective properties changing to a degree that is relevant for their use.

Before use the two components are stored separately, and they are mixed only during or immediately before use. The components are advantageously present in a package consisting of two separate chambers.

Typically the two components are mixed using static mixers or with the aid of dy-namic mixers. During mixing it is to make sure that the two components are mixed as homogeneously as possible. If the two components are mixed poorly, local deviations from the advantageous mixing ratio occur, which can result in deterioration of the mechanical properties.

In a preferred embodiment the isocyanates of the second component are present in free form. For use of such a composition the two components are mixed with one another shortly before or during application. The mixing ratio between the two components is preferably selected such that the isocyanate groups and groups reactive toward isocyanates are present in a suitable ratio, as described in the preceding. In parts by weight, the mixing ratio between the first and the second components is typically in the range of 1:10 to 10:1. The mixing can take place continuously or batchwise. In this process it is advantageous to make sure that too much time does not elapse between mixing the components and application, since this would lead to problems, for example delayed or incomplete formation of the adhesion with the substrate. The mixing especially takes place at ambient temperature or at elevated temperature, especially at a temperature in the range of 15 to 40° C.

Upon contact of the first component with free isocyanate groups of the second component the curing begins through chemical reaction. The following processes especially occur: hydroxyl groups react with free isocyanate groups at moderate speed. Blocked amino groups of the blocked amine Z react with isocyanate groups by hydrolysis in the presence of water. This reaction is additionally influenced by the availability of water in the composition. The water required for hydrolysis can either already be present in the mixed composition or it can penetrate into the composition from the outside, for example in the form of humidity. The isocyanate groups react with the hydrolyzing aldimino or oxazolidino groups, liberating a ketone or especially an aldehyde. If the ketone or the aldehyde in addition to the carbonyl group contains groups reactive toward isocyanate groups, for example one or several hydroxyl groups, these likewise react with isocyanate groups that are present. Excess isocyanate groups in the composition react with moisture that is present. As a result of these reactions the composition cures to form a solid material. This process is also known as crosslinking Aldehydes or ketones released, depending on their volatility and the prevailing ambient conditions, can diffuse out of the curing or cured composition or remain in the cured composition.

In another embodiment the isocyanates of the second component are not present in free form, but as surface-deactivated polyisocyanate that is solid at room temperature. In this case curing does not take place after the mixing of the two components as long as the mixed composition is protected from the effect of excessive heat. In the mixed state the composition can be stored over a long time period before it is finally heated for use, especially to a temperature above 80° C., and the isocyanate groups are activated. The mixed composition, which has not yet come into contact with heat, can be stored in a suitable container, especially a drum, hobbock, bag, bucket, canister, cartridge or tube. It can be applied at a later time and finally cured by the application of heat. However, it can also be applied shortly after mixing and cured later by application of heat. Or it can be heated even during mixing to such an extent that curing takes place.

An additional object of the invention is thus a cured composition obtained from the curing of a composition as described in the present document.

The application [word missing in original German] composition takes place on at least one substrate, wherein the following are particularly suitable:
glass, glass ceramic, concrete, mortar, brick, tile, plaster and natural stone such as granite or marble;
metals and alloys, such as aluminum, iron, steel and nonferrous metals, as well as surface-treated metals and alloys, such as zinc- or chrome-plated metals;
leather, textiles, paper, wood, with resins, for example phenolic, melamine or epoxy resins, resin-textile composites and other so-called polymer composites;
plastics, such as polyvinyl chloride (hard and soft PVC), acrylonitrile-buta-diene-styrene copolymers (ABS), polycarbonate (PC), polyamide (PA), polyester, poly(methyl methacrylate) (PMMA), polyesters, epoxy resins, polyurethanes (PUR), polyoxymethylene (POM), polyolefins (PO), polyethylene (PE) or polypropylene (PP), ethylene/propylene copolymers (EPM) and ethylene/propylene/diene terpolymers (EPDM), wherein the plastics can preferably be surface-treated with plasma, corona or flame;
fiber-reinforced plastics, such as carbon fiber-reinforced plastics (CFRP), glass fiber-reinforced plastics (GFRP) and sheet molding compounds (SMC);
coated substrates, such as powder-coated metals or alloys;
paints and lacquers, especially automobile top coats.

If necessary the substrates can be pretreated before the composition is applied. Such pretreatments especially comprise physical and/or chemical cleaning methods, for example grinding, sand-blasting, shot-blasting, brushing or the like, wherein dust produced during the process is advantageously vacuumed up, as well as further treatment with cleaners or solvents or the application of an adhesive promoter, an adhesive promoter solution or a primer.

The composition is advantageously usable as an adhesive, sealant, coating or potting compound, especially for applications in which elastic properties and a certain strength are required. It can especially be used for adhesion, waterproofing and coating applications in the construction and fabrication industries and in motor vehicle construction, especially for parquet bonding, attachment parts bonding, cavity sealing, mounting, vehicle body bonding, windshield bonding, joint sealing, seam sealing, anchoring, floor covering, as a protective coating, pipe coating or primer.

The use of the composition results in an article containing the cured composition.

This article is especially a structure, especially an above-ground or below-ground structure, or an item of industrial or consumer goods, especially a window, a household appliance, a rotor blade of a wind-power plant or a means of transportation, especially a vehicle, preferably an automobile, a bus, a truck, a train or a ship, as well as an airplane or a helicopter; or a mounted part of such an article, or an article from the furniture, textile or packaging industry.

The two-component composition described is characterized by advantageous properties. It has a relatively long open time, so that it can be applied easily. The curing then takes place rapidly and largely free from bubbles, wherein high early strengths and final strengths develop, depending on the starting materials used. The final strength is particularly high due to the combination of blocked amine Z and catalyst K. This indicates that the amine on which the blocked amine Z is based is incorporated well into the cured polymer during curing. For compositions, containing both polyols and blocked amines, this is by no means obvious. Specifically, with the other customary catalysts from the prior art, such as tertiary amines, dialkyltin(IV) compounds, tin(II) compounds, zinc(II) compounds or titanium(IV) compounds, the curing of combinations of blocked amines Z and polyols is massively disturbed, so that the strengths achieved are often massively lower than for those without blocked amines Z. Sometimes bubbles extending to the point of foaming of the composition develop during curing under moist conditions.

The composition described can especially be used as adhesive for elastic or structural bonded joints, for example in motor vehicle construction, especially for the attachment of parts, such as plastic covers, garnish molding, flanges, bumpers, driving cabs or other parts attached to the lacquered body of the vehicle, or the cementing of windshields into the body.

An additional aspect of the present invention relates to a method for bonding a first substrate with a second substrate. The adhesive can be used in a method for bonding a first substrate with a second substrate, in which the method comprises the following steps:
mixing the two above-described components,
applying the mixed adhesive to at least one of the substrate surfaces to be bonded,
placing the substrates to be bonded together within the open time,
curing the adhesive.

In this process the two substrates may consist of the same or different materials.

This described bonding method results in an article in which the adhesive binds two substrates together by force fit.

This article is especially a civil engineering structure, for example a bridge, an industrial commodity or a consumer good, especially a window, a rotor blade for a wind-power plant or a means of transportation, especially a vehicle, preferably an automobile, bus, truck, a train or a ship, as well as an airplane or a helicopter; or a mounted part of such an article.

An additional object of the invention is an article obtained from the above-described method for bonding.

### EXAMPLES

In the following exemplary embodiments are presented which are intended to explain the invention described in further detail. Naturally the invention is not limited to these exemplary embodiments described.

“Standard climate” is defined as a temperature of 23±1° C. and a relative humidity of 50±5%.

### 1. Substances Used:

| | |
|---|---|
| Polyiso- | Modified diphenylmethane diisocyanate containing MDI-carbodiimide |
| cyanate-1 | adducts, liquid at room temperature, NCO content 28 wt-% |
| | (Desmodur ® CD from Bayer) |
| Polyiso- | Modified diphenylmethane diisocyanate containing MDI-carbodiimide |
| cyanate-2 | adducts, liquid at room temperature, NCO content 29.4 wt-% (Isonate ® |
| | M 143 from Dow) |
| Polyiso- | Dimeric 2,4-toluylene diisocyanate, particle size approx. 5-50 μm, |
| cyanate-3 | NCO content 24.0 wt-% (Addolink ® TT from Rhein Chemie) |
| Polyol | EO-endcapped polyoxypropylenetriol, OH number 34.7 mg KOH/g |
| | (Voranol ® CP 4755 from Dow) |
| Ald-1 | Dialdimine from 1,6-hexamethylenediamine and 2,2-dimethyl-3- |
| | lauroyloxypropanal, amine number 160 mg KOH/g |
| Ald-2) | Dialdimine from 1,6-hexamethylenediamine and 2,2-dimethyl-3-(N- |
| | morpholino)-propanal, amine number 265 mg KOH/g |
| Ald-3 | Dialdimine from 1,6-hexamethylenediamine and 2,2-dimethyl-3- |
| | phenylpropanal, amine number 248 mg KOH/g |
| Ald-4 | Aldimine from 2-(2-aminoethoxy)ethanol and 2,2-dimethyl-3-lauroyl- |
| | oxypropanal, amine number 147 mg KOH/g |
| Ald-5 | Dialdimine from 1,6-hexamethylenediamine and Aldehyde 1, |
| | amine number 423 mg KOH/g |
| Ald-6 | Dialdimine from polyoxypropylene-diamine with amine number 465 |
| | mg KOH/g (Jeffamine ® D-230 from Huntsman) and Aldehyde 1, amine |
| | number 341.6 mg KOH/g |
| Oxa-1 | Bis-Oxazolidine with amine number 232 mg KOH/g: bis-urethane |
| | from hexamethylenediisocyanate and 2-isopropyl-3-(2-hydroxy- |
| | ethyl-)oxazolidine (Hardener OZ from Bayer) |
| Ket-1 | Diketimine from 1,6-hexamethylenediamine and 4-methyl-pentan-2- |
| | one, amine number 396 mg KOH/g |
| Polyether | Polyoxypropylene diamine, amine number 248 mg KOH/g (Jeffamine ® |
| diamine | D-400 from Huntsman) |
| MXDA | 1,3-Bis-(aminomethyl)benzene |
| Silica | Pyrogenic silica, hydrophobically modified |
| Bi-1 | Bismuth(III)-carboxylate, bismuth content 12.0 wt-% |
| | (K-Kat ® XC-C227 from King Industries) |
| Bi-2 | Bismuth(III)-carboxylate, bismuth content 20.0 wt-% |
| | (K-Kat ® XC-B221 from King Industries) |
| Bi-3 | Bismuth(III)-carboxylate, bismuth content 25.0 wt-% |
| | (K-Kat ® 348 from King Industries) |
| Bi-4 | Bismuth(III)-neodecanoate oxinate in neodecanoic acid/diisodecyl- |
| | phthalate, bismuth content 5.8 wt-% |
| Bi-5 | Bismuth(III)-tris(N,N-diethyl-3-oxo-butanamidate) in neodecanoic |
| | acid, bismuth content 9.3 wt-% |
| Bi-6 | Bismuth(III)-tris(neodecanoate) in neodecanoic acid, bismuth content |
| | 16.0 wt-% (Coscat ® 83 from Erbslöh); |
| Zr-1 | Zirconium chelate complex in reactive diluent and tert-butyl acetate, |
| | zirconium content 3.5 wt-% (K-Kat ® A-209 from King Industries) |
| Zr-2 | Zirconium(IV)-tetrakis(1,3-diphenylpropane-1,3-dionate) in tetra- |
| | ethylene glycol dimethyl ether/acetyl acetone, zirconium content 1.8 |
| | wt-% |
| DABCO | 1,4-Diazabicyclo[2.2.2]octane, 33.0 wt-% in dipropylene glycol |
| | (DABCO 33 LV ® from Air Products) |
| DBTDL | Dibutyltin dilaurate in diisodecyl phthalate, tin content 1.9 wt-% (from |
| | Sigma-Aldrich) |
| Sn-1 | Tin(II)-2-ethylhexanoate, tin content 28.0 wt-% (from Sigma-Aldrich) |
| Zn-1 | Zinc(II)-2-ethylhexanoate, zinc content 22.0 wt-% (from Alpha Aesar) |
| Ti-1 | Titanium(IV)-bis-(ethylacetoacetato)-diisobutylate, titanium content |
| | 9.9 wt-% (Tyzor ® IBAY from Du Pont/Dorf Ketal) |

Aldehyde 1 was produced as described in EP 2 030 965, Example 2. It mainly contained 3-bis-(2-hydroxypropyl)amino-2,2-dimethylpropanal.
Bi-4 was produced by mixing 1.25 g of Bi-6 and a solution of 0.44 g of 8-hydroxy-quinoline in 3.27 diisodecyl phthalate, heating with stirring for 2 hours to 80° C. and then cooling.
Bi-5 was produced by mixing 7.75 g of Bi-6 and 2.85 g of N,N-diethyl-3-oxobutanamide, heating with stirring for 2 hours to 80° C., then cooling.
Zr-2 was produced by mixing 9.36 g of zirconium(IV)-tetrakis(isopropoxide) 70% in isopropanol and 17.94 g of 1,3-diphenyl-1,3-propanedione, stirring for 2 hours at 25° C., then freed from the volatile constituents under vacuum and finally dissolving the solid obtained in a mixture of 40 g of tetraethylene glycol dimethyl ether and 40 g of acetylacetone.
The thixotropizing paste was produced by placing 3000 g of diisodecyl phthalate and 480 g of 4,4′-methylene diphenyl diisocyanate (Desmodur® 44 MC L, Bayer) in a vacuum mixer and heating gently, then mixing stirring thoroughly and slowly dropping in 270 g of monobutylamine. The paste produced was stirred for an additional hour under vacuum and cooling.
Polymer-1 was produced by reacting 1300 g of polyoxypropylene-diol (Acclaim® 4200 N, Bayer; OH number 28.5 mg KOH/g), 2600 g of polyoxypropylene-polyoxyethylene-triol (Caradol® MD34-02, Shell; OH number 35.0 mg KOH/g), 600 g of 4,4′-methylenediphenyl diisocyanate (Desmodur® 44 MC L, Bayer) and 500 g of diisodecyl phthalate by known methods at 80° C. to form an NCO-terminated polyurethane polymer with a free isocyanate group content of 2.05 wt-%.

### 2. Production of Polyurethane Compositions

For each composition, the constituents of the first component (“component 1”) specified in Tables 1 to 8 in the quantities shown (in parts by weight) were processed into a homogeneous paste using a centrifugal mixer (SpeedMixer™ DAC 150, FlackTek Inc.) with exclusion of moisture and stored. The constituents of the second component (“component 2”) shown in tables 1 to 8 were then processed and stored in the same way. Then the two components were worked using the centrifugal mixer with exclusion of moisture into a homogeneous paste and this paste was tested immediately thereafter as follows:
As a measure for the open time, the time to freedom from tackiness (“tack-free time”) was determined. For this purpose several grams of the composition were applied in a layer thickness of approx. 2 mm to cardboard and under standard climate conditions, the time was determined until which for the first time no residues remained on the pipette, when the surface of the composition was tapped lightly with a pipette made of LDPE.
To determine the mechanical properties, the composition was cast or pressed onto a PTFE-coated foil to form a 2 mm thick film; if the composition was not self-leveling, this film was stored for 7 days in a standard climate, several dumbbells 75 mm long with a bar length of 30 mm and a bar width of 4 mm were punched out from the film and tested according to DIN EN 53504 at a drawing speed of 200 mm/min for tensile strength (breaking strength), elongation at break and modulus of elasticity (at 0.5-5% elongation). In this testing, the value of the modulus of elasticity and the tensile strength are determined as measures for the strength of the composition.
The formation of bubbles was assessed visually on the same film.
The terms “mEq Bi/Eq NCO” and “mEq Zr/Eq NCO” were used to designate the ratio of the number of milliequivalents of bismuth or zirconium to the number of NCO equivalents in the composition.
The results are presented in tables 1 to 8.
Compositions Z-1 to Z-34 are examples according to the invention. Compositions Ref-1 to Ref-22 are comparison examples.

TABLE 1
Composition (in parts by weight) and properties of Z-1 to Z-7

| Composition | Z-1 | Z-2 | Z-3 | Z-4 | Z-5 | Z-6 | Z-7 |
|---|---|---|---|---|---|---|---|
| Component-1: | | | | | | | |
| polyol | 90.00 | 90.00 | 90.00 | 90.00 | 93.60 | 93.50 | 96.40 |
| blocked amine | Ald-1, | Ald-1, | Ald-1, | Ald-1, | Ald-2, | Ald-3, | Oxa-1, |
| | 10.00 | 10.00 | 10.00 | 10.00 | 6.40 | 6.50 | 3.60 |
| catalyst | Bi-1, | Bi-3, | Bi-4, | Bi-5, | Bi-1, | Bi-1, | Bi-1, |
| | 0.13 | 0.07 | 0.06 | 0.03 | 0.10 | 0.13 | 0.10 |
| Component-2: | | | | | | | |
| polyisocyanate-1 | 13.37 | 13.37 | 13.37 | 13.37 | 13.91 | 13.64 | 14.08 |
| salicylic acid¹ | 0.20 | 0.20 | 0.20 | 0.20 | 0.20 | 0.20 | 0.20 |
| mEq Bi/Eq NCO | 0.84 | 0.94 | 0.19 | 0.15 | 0.62 | 0.82 | 0.61 |
| Tack-free time | 41 | 12 | 34 | 50 | 16 | 50 | 52 |
| [min] | | | | | | | |
| Tensile strength | 1.22 | 0.87 | 1.36 | 1.4 | 1.5 | 1.5 | 1.3 |
| [MPa] | | | | | | | |
| Elongation at | 84 | 71 | 99 | 99 | 95 | 103 | 88 |
| break [%] | | | | | | | |
| E-modulus [MPa] | 2.5 | 1.8 | 2.6 | 2.7 | 3.3 | 2.9 | 2.3 |
| Bubble formation | no | no | no | no | no | no | no |

¹5% in dioctyl adipate

TABLE 2
Composition and (in parts by weight) properties of Z-8 to Z-16

| Composition | Z-8 | Z-9 | Z-10 | Z-11 | Z-12 | Z-13 | Z-14 | Z-15 | Z-16 |
|---|---|---|---|---|---|---|---|---|---|
| Component 1: | | | | | | | | | |
| polyol | 90.00 | 90.00 | 90.00 | 90.00 | 90.00 | 93.05 | 93.05 | 93.05 | 93.50 |
| blocked amine | Ald-1, | Ald-1, | Ald-1, | Ald-1, | Ald-1, | Ald-2, | Ald-2, | Ald-2, | Ald-3, |
| | 10.00 | 10.00 | 10.00 | 10.00 | 10.00 | 6.95 | 6.95 | 6.95 | 6.50 |
| water | 0.40 | 0.40 | 0.40 | 0.40 | 0.40 | 0.40 | 0.40 | 0.40 | 0.26 |
| Component 2: | | | | | | | | | |
| polyisocyanate-1 | 13.37 | 13.37 | 13.37 | 13.37 | 13.37 | 13.67 | 13.67 | 13.67 | 13.64 |
| catalyst | Bi-1, | Bi-2, | Bi-3, | Bi-4, | Bi-5, | Bi-1, | Bi-4, | Bi-5, | Bi-1, |
| | 0.28 | 0.17 | 0.13 | 0.39 | 0.12 | 0.09 | 0.06 | 0.17 | 0.13 |
| salicylic acid¹ | 0.20 | 0.20 | 0.20 | 0.20 | 0.20 | 0.20 | 0.20 | 0.20 | 0.20 |
| mEq Bi/Eq NCO | 1.80 | 1.83 | 1.74 | 1.21 | 0.60 | 0.57 | 0.18 | 0.83 | 0.82 |
| Tack-free time | 20 | 17 | 22 | 19 | 26 | 26 | 20 | 9 | 70 |
| [min] | | | | | | | | | |
| Tensile strength | 1.7 | 1.5 | 1.3 | 1.5 | 1.8 | 1.7 | 1.8 | 2.1 | 1.4 |
| [MPa] | | | | | | | | | |
| Elongation at | 104 | 92 | 72 | 77 | 102 | 123 | 118 | 133 | 97 |
| break [%] | | | | | | | | | |
| E-modulus [MPa] | 5.1 | 4.5 | 4.4 | 5.1 | 6.1 | 3.1 | 3.3 | 4.5 | 2.9 |
| Bubble formation | no | no | no | no | no | no | no | no | no |

¹5% in dioctyl adipate

TABLE 3
Composition (in parts by weight) and properties of Z-17 to Z-25

| Composition | Z-17 | Z-18 | Z-19 | Z-20 | Z-21 | Z-22 | Z-23 | Z-24 | Z-25 |
|---|---|---|---|---|---|---|---|---|---|
| Component 1: | | | | | | | | | |
| polyol | 90.00 | 90.00 | 93.60 | 93.60 | 93.60 | 93.50 | 93.50 | 96.40 | 96.40 |
| catalyst | Zr-1, | Zr-2, | Zr-1, | Zr-2, | — | Zr-2, | — | Zr-1, | Zr-2, |
| | 0.61 | 0.86 | 0.57 | 0.86 | | 0.82 | | 0.58 | 0.89 |
| blocked amine | — | — | Ald-2, | Ald-2, | Ald-2, | — | Ald-3, | Oxa-1, | Oxa-1, |
| | | | 6.40 | 6.40 | 6.40 | | 6.50 | 3.60 | 3.60 |
| salicylic acid¹ | 0.20 | 0.20 | 0.20 | 0.20 | 0.20 | 0.20 | 0.20 | 0.20 | 0.20 |
| water | — | — | — | — | 0.40 | — | 0.40 | — | — |
| Component 2: | | | | | | | | | |
| polyisocyanate-1 | 13.37 | 13.37 | 13.64 | 13.64 | 13.67 | 13.64 | 13.64 | 14.08 | 14.08 |
| blocked amine | Ald-1, | Ald-1, | — | — | — | Ald-3, | — | — | — |
| | 10.00 | 10.00 | | | | 6.50 | | | |
| catalyst | — | — | — | — | Zr-2, | — | Zr-2, | — | — |
| | | | | | 0.85 | | 1.1 | | |
| mEq Zr/Eq NCO | 2.63 | 1.90 | 2.41 | 1.87 | 1.85 | 1.78 | 2.4 | 2.37 | 1.87 |
| Tack-free time | 39 | 62 | 18 | 21 | 18 | 30 | 30 | 25 | 30 |
| [min] | | | | | | | | | |
| Tensile strength | 1.1 | 1.5 | 1.3 | 1.2 | 1.8 | 1.8 | 1.7 | 1.0 | 1.0 |
| [MPa] | | | | | | | | | |
| Elongation at | 85 | 104 | 78 | 66 | 123 | 103 | 96 | 43 | 44 |
| break [%] | | | | | | | | | |
| E-modulus [MPa] | 2.3 | 2.8 | 3.0 | 2.7 | 3.5 | 3.6 | 4.0 | 2.9 | 2.9 |
| Bubble formation | no | no | no | no | no | no | no | no | no |

¹5% in dioctyl adipate

TABLE 4
Composition (in parts by weight) and properties of Ref-1 to Ref-7

| Composition | Ref-1 | Ref-2 | Ref-3 | Ref-4 | Ref-5 | Ref-6 | Ref-7 |
|---|---|---|---|---|---|---|---|
| Component 1: | | | | | | | |
| polyol | 90.00 | 90.00 | 96.40 | 90.00 | 90.00 | 96.40 | 90.00 |
| blocked amine | Ald-1, | Ald-1, | Oxa-1, | Ald-1, | Ald-1, | Oxa-1, | Ald-1, |
| | 10.00 | 10.00 | 3.60 | 10.00 | 10.00 | 3.60 | 10.00 |
| catalyst | DABCO | DABCO | DABCO | DBTDL | DBTDL | DBTDL | Zn-1, |
| | 0.23 | 0.22 | 0.22 | 0.11 | 0.10 | 0.09 | 0.83 |
| water | — | 0.40 | — | — | 0.40 | — | — |
| Component 2: | | | | | | | |
| polyisocyanate-1 | 13.37 | 13.37 | 14.08 | 13.37 | 13.37 | 14.08 | 13.37 |
| salicylic acid¹ | 0.20 | 0.20 | 0.20 | 0.20 | 0.20 | 0.20 | 0.20 |
| Tack-free time | 30 | 25 | 30 | 14 | 19 | 13 | 35 |
| [min] | | | | | | | |
| Tensile strength | 0.6 | 0.2 | 0.9 | 0.7 | 0.7 | 1.0 | 0.6 |
| [MPa] | | | | | | | |
| Elongation at | 65 | 52 | 82 | 85 | 80 | 83 | 76 |
| break [%] | | | | | | | |
| E-modulus [MPa] | 1.1 | 0.4 | 1.8 | 1.3 | 1.2 | 1.9 | 1.2 |
| Bubble formation | some | many² | some | some | many | none | some |

¹5% in dioctyl adipate
²Foam

TABLE 5
Composition (in parts by weight) and properties of Ref-8 to Ref-14

| Composition | Ref-8 | Ref-9 | Ref-10 | Ref-11 | Ref-12 | Ref-13 | Ref-14 |
|---|---|---|---|---|---|---|---|
| Component 1: | | | | | | | |
| polyol | 90.00 | 90.00 | 100.00 | 100.00 | 95.80 | 95.80 | 95.80 |
| blocked amine | Ald-1, | Ald-1, | — | — | Ket-1, | Ket-1, | Ket-1, |
| | 10.00 | 10.00 | | | 4.20 | 4.20 | 4.20 |
| catalyst | Sn-1, | Ti-1, | Bi-1, | Zr-1, | Bi-1, | Zr-1, | DBTDL |
| | 0.10 | 1.04 | 0.12 | 0.60 | 0.10 | 0.60 | 0.09 |
| Component 2: | | | | | | | |
| polyisocyanate-1 | 13.37 | 13.37 | 9.77 | 9.77 | 14.04 | 14.04 | 14.04 |
| salicylic acid¹ | 0.20 | 0.20 | — | | 0.20 | 0.20 | 0.20 |
| mEq Bi/Eq NCO | — | — | 1.06 | — | 0.61 | — | — |
| mEq Zr/Eq NCO | — | — | — | 3.53 | — | 2.46 | — |
| Tack-free time | 10 | 14 | 22 | 20 | 9 | 12 | 4 |
| [min] | | | | | | | |
| Tensile strength | 0.9 | 0.5 | 0.9 | 0.8 | 1.2 | 1.1 | 1.1 |
| [MPa] | | | | | | | |
| Elongation at | 84 | 98 | 116 | 56 | 99 | 80 | 75 |
| break [%] | | | | | | | |
| E-modulus [MPa] | 1.6 | 0.7 | 1.3 | 2.0 | 2.0 | 2.1 | 2.2 |
| Bubble formation | no | no | no | no | no | no | no |

¹5% in dioctyl adipate

It is apparent from the comparison compositions Ref-12 to Ref-14 that for the diketimine Ket-1 increased strengths were not achieved with the bismuth and zirconium catalysts compared with the conventional tin catalyst DBTDL.

TABLE 6
Composition (in parts by weight) and properties
of Z-26 to Z-28 and Ref-15 to Ref-16

| Composition | Z-26 | Z-27 | Ref-15 | Z-28 | Ref-16 |
|---|---|---|---|---|---|
| Component 1: | | | | | |
| polyol | 75.30 | 75.30 | 75.30 | 91.28 | 112.90 |
| blocked amine | Ald-1, | Ald-1, | Ald-1, | — | — |
| | 8.54 | 8.54 | 8.54 | | |
| catalyst | — | — | DABCO, | Bi-1, | Bi-1, |
| | | | 0.26 | 0.13 | 0.18 |
| Thixotropic paste | 10.0 | 10.0 | 10.0 | — | — |
| Chalk | 37.0 | 37.0 | 37.0 | — | — |
| Component 2: | | | | | |
| polyisocyanate-1 | 10.00 | 10.00 | 10.00 | 10.00 | 10.00 |
| polymer-1 | 14.00 | 14.00 | 14.00 | 14.00 ¹ | 14.00 |
| blocked amine | — | — | — | Ald-4, | — |
| | | | | 2.48 ² | |
| catalyst | Bi-1, | Zr-1, | — | — | — |
| | 0.17 | 0.99 | | | |
| silica | 1.00 | 1.00 | 1.00 | — | — |
| salicylic acid ¹ | 0.20 | 0.20 | 0.20 | 0.20 | — |
| mEq Bi/Eq NCO | 1.33 | — | — | 1.02 | 1.41 |
| mEqZr/EqNCO | — | 5.17 | — | — | — |
| Tack-free time | 15 | 26 | 21 | 41 | 14 |
| [min] | | | | | |
| Tensile strength | 1.8 | 1.4 | 1.1 | 0.9 | 0.8 |
| [MPa] | | | | | |
| Elongation at | 172 | 129 | 91 | 81 | 99 |
| break [%] | | | | | |
| E-modulus [MPa] | 2.8 | 2.5 | 2.3 | 1.7 | 1.4 |
| Bubble formation | no | no | no | no | no |

¹ 5% in dioctyl adipate
² The polymer-1 and Ald-4 were mixed separately, allowed to stand for 1 h at 60° C., cooled to 25° C. and then used.

TABLE 7
Composition (in parts by weight) and properties
of Z-29 to Z-30 and Ref-17 to Ref-18

| Composition | Z-29 | Z-30 | Ref-17 | Ref-18 |
|---|---|---|---|---|
| Component 1: | | | | |
| polyol | 50.44 | 50.44 | 50.44 | 50.44 |
| 1,4-butanediol | 8.07 | 8.07 | 8.07 | 8.07 |
| blocked amine | Ald-1, | Ald-1, | Ald-1, | Ald-1, |
| | 5.00 | 5.00 | 5.00 | 5.00 |
| catalyst | — | — | DABCO | DBTDL, |
| | | | 0.24 | 0.33 |
| MXDA | 2.02 | 2.02 | 2.02 | 2.02 |
| molecular sieve² | 4.03 | 4.03 | 4.03 | 4.03 |
| calcined kaolin | 35.37 | 35.37 | 35.37 | 35.37 |
| water | 0.07 | 0.07 | 0.07 | 0.07 |
| Component 2: | | | | |
| polyisocyanate-2 | 36.45 | 36.45 | 36.45 | 36.45 |
| polymer-1 | 52.14 | 52.14 | 52.14 | 52.14 |
| catalyst | Zr-2, | Bi-5, | — | — |
| | 0.35 | 0.17 | | |
| silica | 4.92 | 4.92 | 4.92 | 4.92 |
| salicylic acid¹ | 0.37 | 0.37 | 0.37 | 0.37 |
| mEq Bi/Eq NCO | — | 0.27 | — | — |
| mEq Zr/Eq NCO | 0.25 | — | — | — |
| Tack-free time | 13 | 13 | 10 | 18 |
| [min] | | | | |
| Tensile strength | 10.1 | 10.1 | 9.41 | 9.1 |
| [MPa] | | | | |
| Elongation at | 226 | 212 | 208 | 209 |
| break [%] | | | | |
| E-modulus [MPa] | 36.4 | 31.3 | 27.7 | 31.3 |
| Bubble formation | no | no | yes | yes |

¹5% in dioctyl adipate
²Purmol ® 4ST (Zeochem), pore size 4 Å

The compositions Z-29 and Z-30 are particularly suitable as structural adhesives. They are stable immediately after mixing and have very high strengths with good elasticity when cured.

TABLE 8
Composition (in parts by weight) and properties of Z-31 to Z-34 and Ref-19 to Ref-22

| Composition | Z-31 | Z-32 | Ref-19 | Ref-20 | Z-33 | Z-34 | Ref-21 | Ref-22 |
|---|---|---|---|---|---|---|---|---|
| Component 1: | | | | | | | | |
| polyol | 93.00 | 93.00 | 93.00 | 93.00 | 85.00 | 85.00 | 85.00 | 85.00 |
| blocked amine | Ald-5, | Ald-5, | Ald-5, | Ald-5, | Ald-6, | Ald-6 | Ald-6, | Ald-6 |
| | 7.00 | 7.00 | 7.00 | 7.00 | 15.00 | 15.00 | 15.00 | 15.00 |
| catalyst | — | — | DABCO | DBTDL, | — | — | DABCO | DBTDL, |
| | | | 0.22 | 0.34 | | | 0.50 | 0.40 |
| salicylic acid¹ | 0.20 | 0.40 | 0.40 | 0.40 | 0.50 | 0.50 | 0.50 | 0.50 |
| Component 2: | | | | | | | | |
| polyisocyanate-1 | 21.60 | 21.60 | 21.60 | 21.60 | 30.00 | 30.00 | 30.00 | 30.00 |
| catalyst | Zr-2, | Bi-4, | — | — | Zr-1, | Zr-2, | — | — |
| | 0.75 | 0.05 | | | 1.34 | 1.27 | | |
| mEq Bi/Eq NCO | — | 0.10 | — | — | — | — | — | — |
| mEq Zr/Eq NCO | 1.03 | — | — | — | 2.57 | 1.25 | — | — |
| Tack-free time | 29 | 8 | 22 | 11 | 10 | 33 | 13 | 21 |
| [min] | | | | | | | | |
| Tensile strength | 2.3 | 2.0 | 1.9 | 1.8 | 4.4 | 3.8 | 3.0 | 3.5 |
| [MPa] | | | | | | | | |
| Elongation at | 116 | 92 | 110 | 113 | 173 | 154 | 135 | 174 |
| break [%] | | | | | | | | |
| E-modulus [MPa] | 4.2 | 4.1 | 3.4 | 3.3 | 4.9 | 5.3 | 4.2 | 4.2 |
| Bubble formation | no | no | yes | yes | no | no | yes | yes |

¹5% in dioctyl adipate

The blocked amine Ald-5 or Ald-6 used in compositions Z-31 to Z-34 and Ref-19 to Ref-22 releases an aldehyde containing two OH groups during hydrolysis; it can be incorporated in the polymer during curing of the compositions by reacting with isocyanate groups present.

### 3. Production of Hot-Curing Compositions

For each composition the constituents specified in Table 9 in the quantities shown (in parts by weight) of the first component (“component-1”) were processed using a centrifugal mixer (SpeedMixer™ DAC 150, FlackTek Inc.) with exclusion of moisture into a homogeneous paste and stored. The constituents of the second component (“component 2”) specified in Table 9 were processed and stored in the same way. Then the two components were processed with exclusion of moisture into a homogeneous paste using the centrifugal mixer and stored with exclusion of moisture.

For curing and determination of the mechanical properties, the composition was pressed on a PTFE-coated foil in a heatable press to form a 2 mm thick film, heated for 5 minutes at 140° C. and stored or allowed to cool for one hour under standard climate. Then the tensile strength (breaking strength), elongation at break and E-modulus (at 0.5-5% elongation) were tested as described for the polyurethane compositions.

The ratio of the number of milliequivalents of bismuth to the number of NCO equivalents in the composition was designated as “mEq Bi/Eq NCO”.

The results are presented in Table 9.

TABLE 9
composition (in parts by weight) and properties of Z-35 to Z-38.

| Composition | Z-35 | Z-36 | Z-37 | Z-38 |
|---|---|---|---|---|
| Component 1: | | | | |
| polyol | 33.93 | 33.93 | 33.93 | 31.80 |
| blocked amine | Ald-1, | Ald-1, | Ald-1, | Ald-1, |
| | 1.00 | 1.00 | 1.00 | 3.00 |
| carbon black | 13.00 | 13.00 | 13.00 | 13.00 |
| calcined kaolin | 24.00 | 24.00 | 24.00 | 24.00 |
| Component 2: | | | | |
| polyisocyanate-3 | 5.20 | 5.20 | 5.20 | 6.58 |
| polyether diamine | 1.41 | 1.41 | 1.41 | 1.78 |
| diisodecyl phthalate | 19.07 | 19.07 | 19.07 | 18.25 |
| silica | 2.00 | 2.00 | 2.00 | 2.00 |
| catalyst | Bi-4, | Bi-5, | Bi-6, | Bi-6, |
| | 1.4 | 1.0 | 0.47 | 0.47 |
| salicylic acid¹ | 0.25 | 0.25 | 0.25 | 0.25 |
| mEq Bi/Eq NCO | 16.55 | 18.95 | 15.32 | 12.10 |
| Tensile strength | 6.1 | 6.4 | 5.0 | 7.5 |
| [MPa] | | | | |
| Elongation at | 169 | 243 | 210 | 160 |
| break [%] | | | | |
| E-modulus [MPa] | 13.6 | 10.0 | 12.0 | 16.2 |

¹5% in dioctyl adipate

1. A composition consisting of a first and a second component,
wherein the first component contains at least one polyol and
the second component contains at least one polyisocyanate,
and wherein the composition also contains at least one blocked amine which has an oxazolidino group or an aldimino group as well as at least one additional reactive group selected from the group consisting of oxazolidino groups, aldimino groups, hydroxyl groups, mercapto groups, primary amino groups, secondary amino groups and isocyanate groups,
and the composition additionally comprises at least one catalyst selected from the group consisting of bismuth(III) compounds and zirconium(IV) compounds.

2. The composition according to claim 1, wherein the polyol is a polyether polyol.

3. The composition according to claim 1, wherein the polyol has primary hydroxyl groups.

4. The composition according to claim 1, wherein the polyisocyanate is selected from the group consisting of 4,4′-, 2,4′- and 2,2′-diphenylmethane diisocyanate and any mixtures of these isomers, 2,4- and 2,6-toluylene diisocyanate and any mixtures of these isomers, 1,6-hexamethylene diisocyanate and 1-isocyanato-3,3,5-trimethyl-5-isocyanatomethyl-cyclohexane, oligomers, polymers and derivatives of the isocyanates mentioned and polyurethane polymers containing isocyanate groups based on the isocyanates mentioned, as well as mixtures thereof.

5. The composition according to claim 1, wherein the blocked amine has at least one aldimino group and is based on an amine selected from the group consisting of 1,6-hexamethylenediamine, 1,5-diamino-2-methylpentane, 1,3-pentanediamine, 1-amino-3-aminomethyl-3,5,5-trimethyl-cyclohexane, 2,2,4- and 2,4,4-trimethyl hexamethylene-diamine, 1,3-bis-(aminomethyl)-benzene, 1,3-bis-(aminomethyl)cyclohexane, 1,4-bis-(aminomethyl)cyclohexane, bis-(4-aminocyclohexyl)methane, bis-(4-amino-3-methylcyclohexyl)methane, 3(4), 8(9)-bis-(aminomethyl)-tricyclo[5.2.1.0^{2,6}]decane, 1,2-, 1,3- and 1,4-diaminocyclohexane, 1,4-diamino-2,2,6-trimethylcyclohexane, 3,6-dioxaoctane-1,8-diamine, 4,7-dioxadecane-1,10-diamine, 4-aminomethyl-1,8-octanediamine, polyoxyalkylene-polyamines with two or three amino groups and a molecular weight of up to 600 g/mol, 1,3- and 1,4-phenylenediamine, 2,4- and 2,6-toluylenediamine, 4,4′-, 2,4′- and 2,2′-diaminodiphenylmethane, 3,3′-dichloro-4,4′-diaminodiphenylmethane, 5-amino-1-pentanol, 6-amino-1-hexanol, 4-(2-aminoethyl)-2-hydroxyethylbenzene, 3-aminomethyl-3,5,5-trimethyl-cyclohexanol, 2-(2-aminoethoxy)-ethanol, triethylene glycol-monoamine, 3-(2-hydroxy-ethoxy)propylamine, 3-(2-(2-hydroxy-ethoxy)-ethoxy)propylamine and 3-(6-hydroxy-hexyloxy)propylamine, N-methyl-1,2-ethane diamine, N-ethyl-1,2-ethane diamine, N-cyclohexyl-1,2-ethane diamine, N-methyl-1,3-propanediamine, N-ethyl-1,3-propanediamine, N-butyl-1,3-propanediamine, N-cyclohexyl-1,3-propanediamine, 4-aminomethyl-piperidine, 3-(4-aminobutyl)piperidine, N-coco alkyl-1,3-propanediamine, N-oleyl-1,3-propanediamine, N-soya alkyl-1,3-propanediamine and N-tallow alkyl-1,3-propanediamine.

6. The composition according to claim 1, wherein the blocked amine has at least one aldimino group that cannot be converted to an enamino group by tautomerization.

7. The composition according to claim 6, wherein the blocked amine on the aldimino group has a radical selected from the group consisting of phenyl, 2,2-dimethylpropyl, 2,2-dimethyl-3-phenylpropyl, 2,2-dimethyl-3-acetoxypropyl, 2,2-dimethyl-3-isobutyroxypropyl, 2,2-dimethyl-3-caproyloxypropyl, 2,2-dimethyl-3-benzoyloxypropyl, 2,2-dimethyl-3-capryloyloxypropyl, 2,2-dimethyl-3-caprinoyloxypropyl, 2,2-dimethyl-3-lauroyloxypropyl, 2,2-dimethyl-3-myristoyloxypropyl, 2,2-dimethyl-3-palmitoyloxypropyl, 2,2-dimethyl-3-stearoyloxypropyl, 2,2-dimethyl-3-dimethyl-aminopropyl, 2,2-dimethyl-3-diethylaminopropyl, 2,2-dimethyl-3-dibutylaminopropyl, 2,2-dimethyl-3-(N-pyrrolidino)propyl, 2,2-dimethyl-3-(N-piperidino)propyl, 2,2-dimethyl-3-(N-morpholino)propyl, 2,2-dimethyl-3-(N-(2,6-dimethyl)morpholino)propyl, 2,2-dimethyl-3-(N-(4-methylpiperazino))propyl, 2,2-dimethyl-3-(N-(4-ethylpiperazino))propyl, 2,2-dimethyl-3-(N-benzylmethylamino)propyl, 2,2-dimethyl-3-(N-benzylisopropylamino)propyl, 2,2-dimethyl-3-(N-methylcyclohexylamino)propyl, 2,2-dimethyl-3-bis-(2-methoxyethyl)amino-propyl, 2,2-dimethyl-3-bis-(2-hydroxyethyl)amino-propyl and 2,2-dimethyl-3-bis-(2-hydroxypropyl)amino-propyl.

8. Composition according to claim 1, wherein the catalyst has at least one ligand selected from the group consisting of alcoholates, carboxylates, 1,3-diketonates, 1,3-ketoesterates, oxinates and 1,3-ketoamidates.

9. Composition according to claim 8, wherein the catalyst has at least one ligand selected from the group consisting of 1,3-diketonates, 1,3-ketoesterates, oxinates and 1,3-ketoamidates.

10. Composition according to claim 1, wherein the catalyst is a zirconium(IV) complex.

11. Composition according to claim 10, wherein the zirconium(IV) complex is selected from the group consisting of zirconium(IV)-tetrakis(acetate), zirconium(IV)-tetrakis(octanoate), zirconium(IV)-tetrakis(2-ethylhexanoate), zirconium(IV)-tetrakis(neodecanoate), zirconium(IV)-tetrakis(acetylacetonate), zirconium(IV)-tetrakis(1,3-diphenylpropane-1,3-dionate), zirconium(IV)-tetrakis-(ethyl acetoacetate), zirconium(IV)-tetrakis(N,N-diethyl-3-oxo-butanamidate) and zirconium(IV) complexes with different ones of these ligands mentioned.

12. Composition according to claim 1, wherein as a constituent of the first component it additionally contains at least one diol with two primary hydroxyl groups and a molecular weight in the range of 60 to 150 g/mol.

13. Composition according to claim 1, wherein the blocked amine is present in the composition in such a quantity that the number of its reactive groups including the blocked amino groups relative to the number of OH groups of the polyol and additional alcohols that may be present in the composition is in the range of 0.01 to 10.

14. Composition according to claim 1, wherein as constituents of the first component it additionally contains water or a water-generating substance.

15. A method for bonding a first substrate with a second substrate, which comprises the steps of:
mixing the two components of a composition according to claim 1,
applying the mixed composition to at least one of the substrate surfaces to be bonded,
placing the substrates to be joined together within the open time,
curing the composition.

16. An article obtained from a method for bonding according to claim 15.
